(19) United States
(12) Patent Application Publication
(10) Pub. No.: US 2014/0244678 A1
(43) Pub. Date: Aug. 28, 2014

(54) CUSTOMIZED USER EXPERIENCES

(71) Applicants: Kamal Zamer, Austin, TX (US); Jeremiah Joseph Akin, Pleasant Hill, CA (US); Frank Anthony Nuzzi, Pflugerville, TX (US); Jamie Brett Sowder, Austin, TX (US); Jayasree Mekala, Austin, TX (US)

(72) Inventors: Kamal Zamer, Austin, TX (US); Jeremiah Joseph Akin, Pleasant Hill, CA (US); Frank Anthony Nuzzi, Pflugerville, TX (US); Jamie Brett Sowder, Austin, TX (US); Jayasree Mekala, Austin, TX (US)

(21) Appl. No.: 13/781,531

(22) Filed: Feb. 28, 2013

(51) Int. Cl. G06F 17/30

(52) U.S. Cl. CPC G06F 17/30386
USPC 707/758

(57) ABSTRACT

Systems and methods for customizing a user experience are described. The methods include automatically collecting identifying characteristic information for a current user, comparing the identifying characteristic information to stored user profiles for known users, identifying the current user as a known user, retrieving user preferences for the known user, and presenting the user preferences.

### BACKGROUND

1. Field of the Invention

The present invention generally relates to customizing the experience of a user based on user recognition.

2. Related Art

Many different users may interact with a device separately and at different times. For example, a computer system in a home may be used by different members of a family, and each family member may use the computer to perform different tasks. One user may prefer one color scheme over another, or may choose to run certain applications not needed by another. In some cases, certain programs may be blocked based on who is using the computer.

It can be troublesome to change the settings from user to user. Typically, a user must log another user out, and then log in again using a personalized user name and password. Thus, a need exists for systems and methods that can recognize a user or a group of users and tailor the user experience based on the user's profile and preferences, or the group's profile and preferences.

### BRIEF DESCRIPTION OF THE FIGURES

FIG. 1 is a is a block diagram of a networked system suitable for implementing the methods described herein according to an embodiment;

FIG. 2 is a flowchart showing a method of customizing a user experience according to one embodiment;

FIG. 3 is a flowchart showing a method of customizing a user experience according to another embodiment; and

FIG. 4 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a dynamic system and method for customizing an experience according to one or more user preferences based on recognition of the user. The preference information is correlated to the identity of the user. Unique user profiles are first collected and stored. Each user profile is linked to user preferences that can be retrieved upon recognition of the user. When a user is detected, the user is identified, the preferences linked to that identity are retrieved, and the preferences presented to the user. The user may be one person, a pair of people, or a group of people. When the user is a pair of people, the preferences retrieved and presented are the pair's preferences, instead of the preferences of a single person in the pair. When the user is a group of people, the preferences retrieved and presented are the group as a whole's preferences.

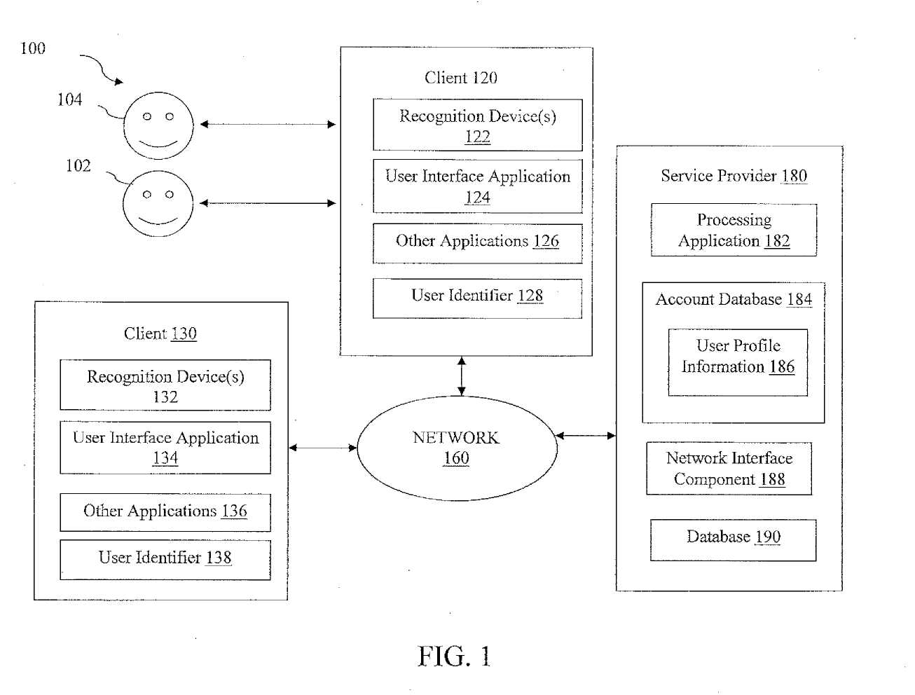

FIG. 1 illustrates an exemplary embodiment of a network-based system 100 for implementing one or more processes described herein over a network 160. As shown, network-based system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities. As shown in FIG. 1, the system 100 includes first client device 120, second client device 130, and one service provider server 180 in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network may comprise a wireless telecommunications network (e.g., mobile cellular phone network) adapted to communicate with other communication networks, such as the Internet. As such, in various embodiments, first client device 120, second client device 130, and service provider server 180 may be associated with a particular link (e.g., a link, such as a URL (Uniform Resource Locator) to an IP (Internet Protocol) address).

The client devices 120 and 130 include one or more recognition devices 122, 132 for collecting identifying characteristics of a user. The characteristics are communicated to the service provider server 180, which is configured to recognize the user based on the collected identifying information. The first computing device 120, second computing device 130, and/or the service provider server 180 are configured to present, e.g., display, user preferences to a recognized user and enable a recognized user to access customized information.

The first client device 120 and second client device 130 may include one or more of a motion sensor, an image sensor (e.g. camera), a voice sensor (e.g. microphone), an optical sensor, and any other kind of recognition device suitable to collect identifying characteristic information regarding a user. Motion sensors such as motion detectors, accelerometers and/or gyroscopes may monitor speed, acceleration, position, rotation, and other characteristics of body and appendage motion. The motion sensor captures movement of a user, such as a pose, position, or gesture. Example gestures include for instance, an “air quote” gesture, a bowing gesture, a curtsey, a cheek-kiss, a finger or hand motion, a head bobble or movement, a high-five, a nod, a raised fist, a salute, a swiping or wave motion, a thumbs-up motion, a hand-moving-in-circle or hand waving gesture, or a finger pointing gesture. An image sensor captures images of the user. A voice sensor captures the voice or sounds made by the user. An optical sensor captures and characterizes light. Identifying characteristics captured by the sensors are collected, stored, and associated with a specific user.

The first client device 120 and second client device 130, in various embodiments, may be implemented using any appropriate combination of hardware and/or software configured for wired and/or wireless communication over the network 160. In various examples, first client device 120 may be implemented as a wireless telephone (e.g., cellular or mobile phone), a tablet, a personal digital assistant (PDA), a personal computer, a notebook computer, and/or various other generally known types of wired and/or wireless computing devices. It should be appreciated that first client device 120 may be referred to as a user device or a customer device without departing from the scope of the present disclosure.

The first client device 120, in one embodiment, includes a user interface application 124, which may be utilized by the user 102 and/or user 104 to conduct transactions (e.g., shopping, purchasing, bidding, etc.) with the service provider server 180 over the network 160. In one aspect, purchase expenses may be directly and/or automatically debited from an account related to the user 102 and/or user 104 via the user interface application 124.

In one implementation, the user interface application 124 comprises a software program, such as a graphical user interface (GUI), executable by a processor that is configured to interface and communicate with the service provider server 180 via the network 160. In another implementation, the user interface application 124 comprises a browser module that provides a network interface to browse information available over the network 160. For example, the user interface application 124 may be implemented, in part, as a web browser to view information available over the network 160.

The first client device 120, in various embodiments, may include other applications 126 as may be desired in one or more embodiments of the present disclosure to provide additional features available to the user 102 and/or user 104. In one example, such other applications 126 may include security applications for implementing client-side security features, programmatic client applications for interfacing with appropriate application programming interfaces (APIs) over the network 160, and/or various other types of generally known programs and/or software applications. In still other examples, the other applications 126 may interface with the user interface application 124 for improved efficiency and convenience.

The first client device 120, in one embodiment, may include at least one user identifier 128, which may be implemented, for example, as operating system registry entries, cookies associated with the user interface application 124, identifiers associated with hardware of the first client device 120, or various other appropriate identifiers. The user identifier 128 may include one or more attributes related to the user 102 and/or user 104, such as personal information related to the user 102 and/or user 104 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 128 may be passed with a user login request to the service provider server 180 via the network 160, and the user identifier 128 may be used by the service provider server 180 to associate the user 102 and/or user 104 with a particular user account maintained by the service provider server 180.

Second client device 130 may have similar applications and modules as first client device 120. Second client device 130 may also include a user interface application 134 and one or more other applications 136 which may be used, for example, to provide a convenient interface to permit user 102 and/or user 104 to browse information and perform tasks over network 160. For example, in one embodiment, user interface application 134 may be implemented as a web browser configured to view information available over the Internet and communicate with service provider server 180.

Second client device 130 may further include other applications 136 such as security applications for implementing client-side security features, programmatic client applications for interfacing with appropriate application programming interfaces (APIs) over network 160, or other types of applications. Applications 136 may also include email, text, IM, and voice applications that allow user 102 and/or user 104 to communicate through network 160 and receive messages. Second client device 130 includes one or more user identifiers 138 which may be implemented, for example, as operating system registry entries, cookies associated with user interface application 134, identifiers associated with hardware of second client device 130, or other appropriate identifiers, such as used for payment/recipient/device authentication, e.g., the phone number associated with second client device 130.

The user 102 and/or user 104 may communicate with the service provider server 180 through first client device 120 or second client device 130. In one embodiment, first client device 120 is located in the user 102's and/or user 104's house, while second client device 130 is located at user 102 friend's and/or user 104's friend's house. Advantageously, the user 102 and/or user 104 can have a customized experience at any client device operatively connected to the service provider server 180. The user 102's and/or user 104's and/or the combination of user 102 and user 104's preferences follow him or her.

In various implementations, a user profile for user 102, user 104, and/or the combination of user 102 and user 104 is created using data and information obtained from the recognition device(s) 122, 132. For example, facial features, gestures, poses, behavioral information (e.g., habits), body type, voice information, etc. may be used by the service provider server 180 to create at least one user profile for the user 102, user 104, and/or the combination of user 102 and user 104. User preferences associated with the user 102, user 104, and/or the combination of user 102 and user 104 are also collected and stored in connection with the user profile for the user 102, user 104, and/or the combination of user 102 and user 104. This preference information may be a collection of information that was explicitly input by the user 102, user 104, and/or the combination of user 102 and user 104 or inferred about the user 102, user 104, and/or the combination of user 102 and user 104. Input information may be a listing of one or more of the user's interests, category(ies), information on a degree of interest in one or more areas, a listing of the user's likes or dislikes with respect to a service(s) or a way in which a service is presented, and/or any other information. The user profile may be updated with additional user preferences and additional information obtained from the recognition device(s) 122, 132 at any time.

Understanding user preferences also assists in creating customized presentations for the user 102, user 104 and/or the combination of user 102 and user 104. Knowing and analyzing the user preferences, it is possible for the service provider server 180 to develop custom presentations and/or line-ups that recommend certain products and/or services based on the user preferences.

The first client device 120 and second client device 130 may include input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

In various implementations, the user 102 and/or user 104 is able to input data and information into the input device (e.g., a keyboard) of the first client device 120 to supply user preferences and/or to make choices. The user interface may be used by the user 102 and/or user 104 to create and modify a preference. One or more preferences may be used to customize an experience of the user 102 and/or user 104.

The preference information may include but is not limited to one or more of preferred games and games feature settings, television programs or movies, settings on a computer, type of food, products, advertisements, etc. For instance, a specific graphics scheme, color scheme, and text font size may be preferred by the user 102, user 104, or the combination of user 102 and user 104. The preference information for user 102, user 104, or the combination of user 102 and user 104 may be used to customize the first computing device 120, second computing device 130, or experience for user 102, user 104, or the combination of user 102 and user 104 once user 102, user 104, or the combination of user 102 and user 104 is recognized.

The service provider server 180, in various embodiments, may be maintained by an online service provider. The service provider server 180 includes at least one processing application 182, which may be adapted to interact with the first client device 120 and/or second client device 130 via the network 160 to facilitate customized user experiences. In one example, the service provider server 180 may be provided by PayPal, Inc. of San Jose, Calif., USA.

The processing application 182 includes a recognition application, which is used to recognize a current user based on information about known users. Known user data and detected user data may also be stored in some embodiments, and may be used to recognize a current user and/or customize presentation of services based on the identity of the current user. One or more services may be stored that may be customized for presentation to a user based on the identity of the user and preferences of the user.

The service provider server 180, in one embodiment, may be configured to maintain a plurality of user accounts in an account database 184, each of which may include user profile information 186 associated with individual users, including the user 102 and/or user 104, and/or pairs or groups of users, including the pair of user 102 and user 104. For example, user profile information 186 may include identifying characteristics and user preferences (e.g., preferred settings, programs, etc.). In another example, user profile information 186 may include identification information and/or private financial information of the user 102 and/or user 104, such as account numbers, identifiers, passwords, phone numbers, credit card information, banking information, or other types of financial information to facilitate payment. It should be appreciated that the methods and systems described herein may be modified to accommodate users that may or may not be associated with at least one existing user account.

Each user profile stored in account database 184 may include behavioral information for one or more known users, e.g., user 102, user 104, and/or the combination of user 102 and user 104. Frequent or common operations carried out by the known user may be identified, including common types of operations performed with respect to a computer. Such operations may include operations to start a software application and operations to request a particular content or type of content from a software application. Information about the frequent/common operations may also be stored, such as a time of day at which the operation(s) are executed, a speed with which the operation or a set of operations is carried out, a type of input device used to carry out of the operation, or any other suitable data regarding operations.

In accordance with the methods described herein, preference information on known users that may be stored in account database 184 may be compiled in response to direct user input regarding the user (e.g., in response to prompts for user demographic information and/or preference information) and/or through observing user operations that may indicate user preference information. For example, if a known user spends a lot of time reading sports-related web pages, the known user may be detected to have a preference for sports.

The service provider server 180, in various embodiments, may include at least one network interface component (NIC) 188 adapted to communicate with the network 160 including the user interface applications 124, 134 of the client devices 120, 130. In various implementations, the network interface component 188 may comprise a DSL (e.g., Digital Subscriber Line) modem, a PSTN (Public Switched Telephone Network) modern, an Ethernet device, a broadband device, a satellite device and/or various other types of wired and/or wireless network communication devices including microwave, radio frequency (RF), and infrared (IR) communication devices.

The service provider server 180, in various embodiments, may include one or more databases 190 (e.g., internal or external) for storing and tracking information related to users. The database 190 may store, for example, address data for communicating with the first client device 120 and/or second client device 130. The address data may include data for communicating a text message to the first client device 120 and/or second client device 130, an e-mail address at which messages are receivable by the first client device 120 and/or second client device 130, or any other manner for communicating with the first client device 120 and/or second client device 130. Moreover, service provider server 180 may include computer executable instructions that are operative to cause the server 180 to generate message content appropriate for messages to be communicated to the first client device 120 and/or second client device 130.

In some embodiments, the first client device 120 and/or second client device 130 may simply pass the raw or processed data gathered by the recognition device(s) 122, 132, and the service provider server 180 may be responsible for determining the user's identity. In each instance, identity would be determined based on a comparison of the data obtained by the recognition device(s) 122, 132 with some previously stored data obtained in a similar fashion.

The system described above with respect to the embodiment of FIG. 1 may be used to customize a user experience such that when a user or group of users is detected by first client device 120 or second client device 130, data, e.g., identifying characteristics of the user or group of users, is automatically collected. The data is compared with stored user profiles and matched to a known user(s). Preference information for the known user(s) is then retrieved and presented to the user(s).

For example, assume John and his family subscribe to an online streaming movie service. John enjoys watching movies in the evening and is only interested in kungfu movies. His preferences and habits have been previously collected and stored. John enters his living room at night and is detected by his computer. Using, for example, an image sensor, John's facial features are automatically collected by the computer and matched to his user profile. The computer recognizes John based not only on his facial features, but also based on the time of day he is accessing the movie service. John is presented with kungfu movie options.

In another example, John and his wife enjoy watching dramas together. A single user profile for John and his wife, separate from that of John, is created and stored. When the computer detects that John and his wife are in the same room and using the movie service, a pairing preference, i.e., drama movie options are presented. Additionally, when John's entire family (John, wife, and son) is together and looking for a movie to watch, the computer detects that his family is together, and they are presented with “family friendly” movies, a group preference.

In other words, John has one set of preferences, his wife has a second set of preferences, and his son a third set of preferences. When John is with his son, a fourth set of preferences would be displayed. When John is with his wife, a fifth set of preferences would be displayed, and when John is with his wife and son, a sixth set of preferences would be displayed. Typically, one must log on and off of a system to switch between people. The present application accommodates pairs and groups of people.

In some embodiments, the user preferences can influence the products and/or services displayed or offered. For instance, if John and his wife really enjoy watching dramas, they can be presented with offers to go see a similar, new movie, or if their favorite movie is in a specific city, they can receive offers to visit that specific city. They can then pay for the offer using the service provider.

Many other examples are encompassed by the present disclosure. In a village with a shared computer, each user is recognized by an image sensor (or other recognition device) so that each user is presented with their specific user interface layout and programs that they use. In a university with a shared computer, each student's unique information (information regarding their major, class schedule, textbooks, projects, etc.) is available when the computer recognizes the student. At a drive through restaurant, a camera, microphone, or other recognition device detects a repeat customer and tailors the menu items and display according to the customer's preferences. A driver enters a family car, and the car's computer system recognizes the driver and moves the mirrors, adjusts the seat and temperature, and provides the radio presets for that driver.

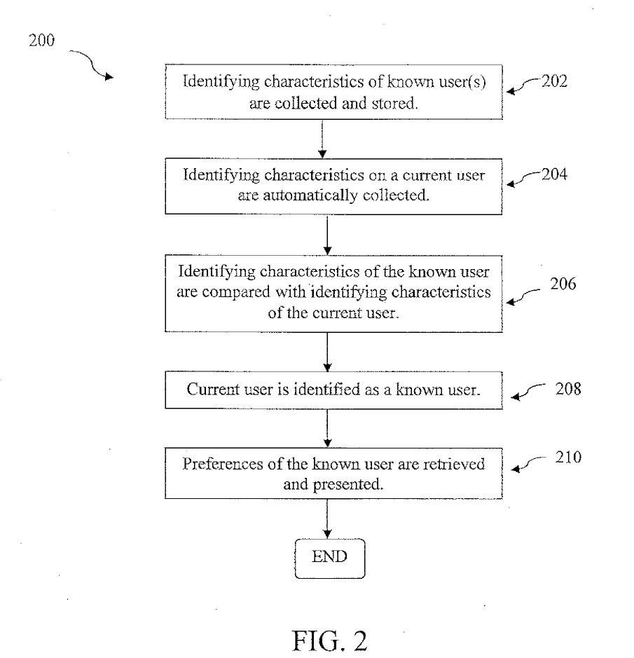

Referring now to FIG. 2, a flowchart of a method 200 for customizing a user experience for a current user is illustrated according to an embodiment of the present disclosure. It should be appreciated that the method illustrated in the embodiment of FIG. 2 may be implemented by the system illustrated in FIG. 1 according to one or more embodiments. The current user may be one person, a pair of people, or a group of people.

The method 200 begins at step 202, in which identifying characteristics of known users are compiled or collected and stored. Step 202 may be done in any suitable manner, including by observing operations of known users and/or collecting information of known users from recognition device(s) 122, 132. Some information about known users may be compiled by observing one operation of a known user while other information may be compiled through repeated observation of various operations of a known user over time. For example, if a user is detected and it is observed that he/she watches a comedy show every night, that comedy or comedies in general may be associated with the known user and stored after one operation. As another example, if a user tends to execute a spreadsheet application program often and tends not to play computer games often, information on these trends or habits may be collected from observing operations of the known user over time.

In some embodiments, identifying characteristics may be aggregated until trends can be identified as corresponding to distinct users. For example, trends in behavior, e.g., habits, may be matched to specific time periods, such as different types of behavior in the early evening and late at night that may correspond to two different users that use a computer at different times. Any suitable trend may be identified. These trends, once identified, may be used to separate aggregated characteristics from a large span of time and possibly multiple users into distinct user profiles, each including characteristics on behavior of the known users to which they correspond.

Based on the information compiled on the known users, various characteristics may be identified. For example, a characteristic gesture, habit, body type, movement, voice, way of performing operations (e.g., which input device is used), input such as words or phrases, content, and/or programs and processes may be identified.

In step 204, identifying characteristics regarding a current user are automatically collected, without a need for the current user to log in to an application or program. In some embodiments, the behavior of the current user is observed, such as by observing operations of the current user, and/or information is collected by the recognition device(s) 122, 132. The information regarding the current user is collected in much the same way as described above in step 202. Based on the information collected in step 204, various identifying characteristics of the current user may be identified.

In step 206, the identifying characteristics of the current user from step 204 are compared to identifying characteristics of the one or more known users compiled in step 202. Based on this comparison, similarities may be detected between the current user and one or more known users. This comparison may be carried out in any suitable manner.

Based on this comparison in step 206, and/or through application of one or more statistical correlation techniques—such as those used in regression analysis or segmentation problems—one known user or user profile may be identified as more likely than others to be the current user. This may be because the identifying characteristics of this known user more closely match the identifying characteristics of the current user. The current user may then in step 208 be identified as this known user.

In step 210, preferences associated with the known user are retrieved and presented, e.g., displayed, to the current user. When a service and/or product is to be presented to the user, the preference information for that user may be retrieved and used to customize presentation of the service and/or product in any way. This may involve customizing content that is presented by the service and/or a manner of presenting the content (e.g., display of the content), among other things.

Information may be compiled for the known user identified in step 208 about preferences of the current user. This additional information may be used in step 210 to update preferences of the known user identified in step 208, to be used in customizing presentation of services and/or products to the known user. Information about preferences may be collected in step 210 in any suitable manner, including by observing operations of the current user and inferring preferences and/or by prompting the current user to input preference data for a user profile.

The method 200 of FIG. 2 focuses on matching identifying characteristics, e.g., behavior, of a current user to that of known users and to identify the current user as one of the known users. Once the current user is identified, his or her user preferences are presented to provide a customized user experience.

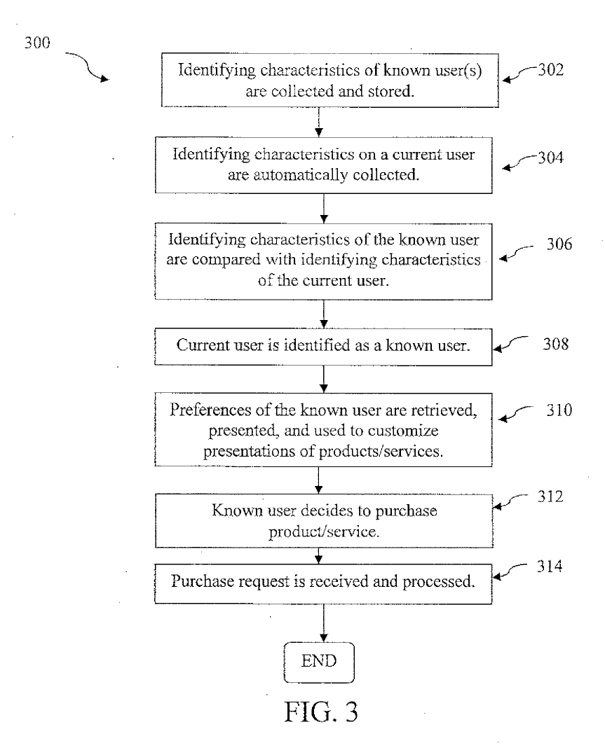

Referring now to FIG. 3, a flowchart of a method 300 for customizing a user experience for a current user is illustrated according to another embodiment of the present disclosure. Steps 302 through 306 are similar to steps 202 through 206 of FIG. 2, and thus, the descriptions of these steps are omitted for brevity.

In step 310, the preferences of the user are retrieved, presented and used to customize presentation of products and/or services to the current user. In some embodiments, the preference information may be used in step 310 to identify advertisements or promotions in which the current user may have an interest from a set of advertisements that have already been downloaded or viewed by the user.

In step 312, if the user decides to purchase the product and/or service displayed, the method proceeds, and the purchase request is communicated electronically to the service provider server 180 from the first client device 120 or second client device 130. For example, the user may place the desired item in a cart, enter payment information, such as funding source and related information, a shopping option, any message, and a confirmation of the purchase, such as through a click, tap, or other means of selection.

In step 314, the purchase request is received and processed by the service provider, which may include crediting an account of a merchant and debiting an account of the user. There is generally no need to authenticate the user because the user will already have been identified as a known user in step 308. After the purchase is processed, the user and/or merchant may be notified, such as by the service provider.

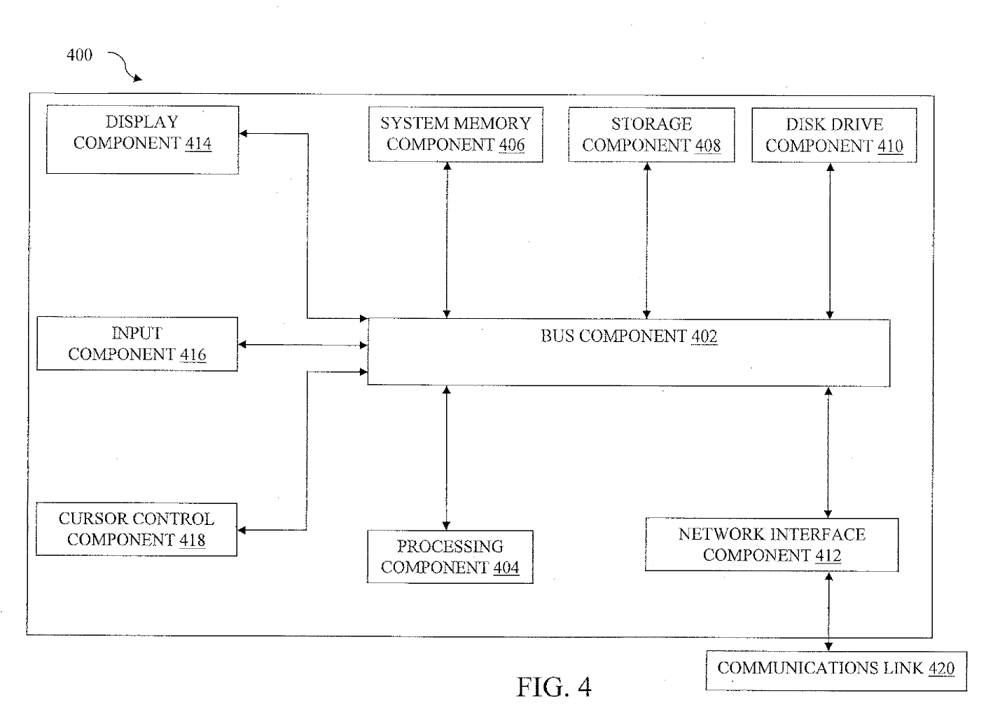

Referring now to FIG. 4, a block diagram of a system 400 is illustrated suitable for implementing embodiments of the present disclosure, including first client device 120, second client device 130, and service provider server 180. System 400, such as part of a cell phone, a tablet, a personal computer and/or a network server, includes a bus 402 or other communication mechanism for communicating information, which interconnects subsystems and components, including one or more of a processing component 404 (e.g., processor, micro-controller, digital signal processor (DSP), etc.), a system memory component 406 (e.g., RAM), a static storage component 408 (e.g., ROM), a network interface component 412, a display component 414 (or alternatively, an interface to an external display), an input component 416 (e.g., keypad or keyboard), and a cursor control component 418 (e.g., a mouse pad).

In accordance with embodiments of the present disclosure, system 400 performs specific operations by processor 404 executing one or more sequences of one or more instructions contained in system memory component 406. Such instructions may be read into system memory component 406 from another computer readable medium, such as static storage component 408. These may include instructions to collect and compare identifying characteristic information, present user preferences, process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 404 for execution. Such a medium may take many forms, including but not limited to, non-volatile media, volatile media, and transmission media. In various implementations, volatile media includes dynamic memory, such as system memory component 406, and transmission media includes coaxial cables, copper wire, and fiber optics, including wires that comprise bus 402. Memory may be used to store visual representations of the different options for searching, auto-synchronizing, making payments or conducting financial transactions. In one example, transmission media may take the faun of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 400. In various other embodiments, a plurality of systems 400 coupled by communication link 420 (e.g., network 160 of FIG. 1, LAN, WLAN, PTSN, or various other wired or wireless networks) may perform instruction sequences to practice the disclosure in coordination with one another. Computer system 400 may transmit and receive messages, data, information and instructions, including one or more programs (i.e., application code) through communication link 420 and communication interface 412. Received program code may be executed by processor 404 as received and/or stored in disk drive component 410 or some other non-volatile storage component for execution.

In view of the present disclosure, it will be appreciated that various methods and systems have been described according to one or more embodiments for facilitating the purchase of tagged items for friends.

Although various components and steps have been described herein as being associated with first client device 120, second client device 130, and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure. For example, although merchant transactions have been described according to one or more embodiments, it should be understood that the present disclosure may also apply to transactions where requests for information, requests for access, or requests to perform certain other transactions may be involved.

Having thus described embodiments of the disclosure, persons of ordinary skill in the art will recognize that changes may be made in form and detail without departing from the scope of the disclosure. Thus the disclosure is limited only by the claims.

What is claimed is:

1. A system, comprising:
a memory device storing user account information for a plurality of known users, wherein the user account information comprises user profiles of known users; and
one or more processors in communication with the memory device and operable to:
automatically collect identifying characteristic information for a current user;
compare the identifying characteristic information to stored user profiles for known users;
identify the current user as a known user;
retrieve user preferences for the known user; and
present the user preferences.

2. The system of claim 1, wherein the stored user profiles and identifying characteristic information comprise facial features, voice, movement, body type, behavior, or combinations thereof.

3. The system of claim 1, wherein the one or more processors is further operable to recommend a product or service based on the user preferences.

4. The system of claim 3, wherein the one or more processors is further operable to receive and process a payment request for the product or service.

5. The system of claim 4, wherein the one or more processors is further operable to authenticate the user based on a matched user profile.

6. The system of claim 1, wherein the current user comprises two or more people.

7. The system of claim 1, wherein the one or more processors is further operable to update a user preference.

8. The system of claim 7, wherein the one or more processors is further operable to store the updated user proference and associate the updated user preference with the known user.

9. A method for customizing a user experience, comprising:
automatically collecting identifying characteristic information for a current user;
comparing, by one or more hardware processors of a service provider, the identifying characteristic information to stored user profiles for known users;
identifying the current user as a known user;
retrieving, by one or more hardware processors of a service provder, user preferences for the known user; and
presenting the user preferences.

10. The method of claim 9, wherein the stored user profiles and identifying characteristic information comprise facial features, voice, movement, body type, behavior, or combinations thereof.

11. The method of claim 9, further comprising recommending a product or service based on the user preferences.

12. The method of claim 11, further comprising receiving and processing a payment request for the product or service.

13. The method of claim 9, wherein the current user comprises two or more people.

14. The method of claim 9, further comprising updating and storing a user preference.

15. A non-transitory machine-readable medium comprising a plurality of machine-readable instructions which, when executed by one or more processors, are adapted to cause the one or more processors to perform a method comprising:
automatically collecting identifying characteristic information for a current user;
comparing the identifying characteristic information to stored user profiles for known users;
identifying the current user as a known user;
retrieving user preferences for the known user; and
presenting the user preferences.

16. The non-transitory machine-readable medium of claim 15, wherein the stored user profiles and identifying characteristic information comprise facial features, voice, movement, body type, behavior, or combinations thereof.

17. The non-transitory machine-readable medium of claim 15, wherein the method further comprises recommending a product or service based on the user preferences.

18. The non-transitory machine-readable medium of claim 17, wherein the method further comprises receiving and processing a payment request for the product or service.

19. The non-transitory machine-readable medium of claim 15, wherein the current user comprises two or more people.

20. The non-transitory machine-readable medium of claim 15, wherein the method further comprises updating and storing a user preference.
